(19) United States
(12) Patent Application Publication
(10) Pub. No.: US 2012/0175140 A1
(43) Pub. Date: Jul. 12, 2012

(54) HAND-HELD POWER TOOL

(76) Inventors: Joachim Hecht, Magstadt (DE); Heiko Roehm, Stuttgart (DE); Tobias Herr, Stuttgart (DE)

(21) Appl. No.: 13/381,846

(22) PCT Filed: Jun. 1, 2010
(86) PCT No.: PCT/EP2010/057658

§ 371 Date: Mar. 27, 2012

(30) Foreign Application Priority Data
Jul. 3, 2009 (DE) 102009027442.1

(51) Int. Cl. B23B 45/16

(52) U.S. Cl. 173/48

(57) ABSTRACT

In a hand-held power tool, in particular an impact drill driver, having a gearbox assemblage, a hammer impact mechanism, and a tool spindle, the gearbox assemblage includes at least one gear stage element which is provided in order to split a power flow so as to make available different rotation speeds for an impact mode and a rotation mode.

### FIELD OF THE INVENTION

The present invention relates to a hand-held power tool.

### BACKGROUND INFORMATION

Certain hand-held power tools, in particular an impact drill driver, having a gearbox assemblage, a hammer impact mechanism, and a tool spindle, are conventional.

### SUMMARY

Example embodiments of the invention provide a hand-held power tool, in particular an impact drill driver, having a gearbox assemblage, a hammer impact mechanism, and a tool spindle.

It is provided that the gearbox assemblage have at least one gear stage element which is provided in order to split a power flow so as to make available different rotation speeds for an impact mode and a rotation mode. A “gearbox assemblage” is to be understood in particular as an assemblage that has at least one gear stage. The gear stage is advantageously arranged as a right-angle gearbox, as a bevel gear gearbox, and/or as another gear stage. The gear stage is arranged particularly advantageously as a planet wheel gear stage. A “hammer impact mechanism” is to be understood in particular as an impact mechanism having at least one linearly moved striker. Advantageously, the hammer impact mechanism moves the striker resiliently and/or pneumatically and/or hydraulically by a gate apparatus, by a wobble bearing, and/or advantageously by an eccentric element. The hammer impact mechanism is thus arranged preferably as a slide impact mechanism, as a wobble bearing impact mechanism, and/or as an eccentric impact mechanism. A “gate impact mechanism” is to be understood in particular as a hammer impact mechanism having a gate apparatus. A gate apparatus generates a linear motion between at least two regions by elements that are movable on a mechanically delimited endless track. A “wobble bearing impact mechanism” is to be understood in particular as a bearing having a finger, which is connected to a drive rotation element of the hammer impact mechanism and whose bearing plane deviates from a plane that is oriented perpendicular to the rotation axis of the drive rotation element. An “eccentric impact mechanism” is to be understood in particular as a hammer impact mechanism which is provided in order to generate, from a rotary motion, a linear motion perpendicular to the rotation axis of the rotary motion. The eccentric impact mechanism preferably has an eccentric element that is connected nonrotatably to the drive rotation element. A “hammer impact mechanism” is in particular to be understood as a ratchet impact mechanism in which a ratchet disk rotatable in an axial direction is uninterruptedly connected fixedly to the hand-held tool housing, and in which in order to generate a pulse, the ratchet disk coacts with a ratchet disk uninterruptedly mechanically connected to the tool spindle. A “ratchet impact mechanism” is, in particular, an impact mechanism in which an impact-generating ratchet disk is rotationally drivable, in which context an axial tooth set of the ratchet disk causes an axial motion of the tool spindle. A “tool spindle” is to be understood in particular as a shaft of the hand-held power tool that, in at least one operating state, transfers a rotary motion to a tool mounting apparatus of the hand-held power tool. A rotation axis of the tool spindle is preferably located on a rotation axis of an inserted tool and/or of the tool mounting apparatus. Particularly advantageously, in at least one operating state the tool spindle transfers a rotary motion and an impact motion to the tool mounting apparatus. Particularly advantageously, at least a part of the tool spindle is connected directly to the tool mounting apparatus. The tool spindle preferably has a mount for the tool mounting apparatus. Alternatively, the tool spindle can be arranged at least partly integrally with the tool mounting apparatus. The tool mounting apparatus is advantageously arranged as a tool chuck, as a hex receptacle, as an SDS receptacle (Special Direct System of Robert Bosch GmbH), and/or as another tool mounting apparatus. “Provided” is to be understood in particular to mean specially equipped and/or designed. A “gear stage element” is to be understood in particular as a sun gear, a ring gear, a planet wheel, another element of the gearbox assemblage, and/or in particular as a planet carrier. “Split” is to be understood in this connection, in particular, to mean that forces that cause torques act on the gear stage element at at least three points such as, in particular, at least one input point and at least two output points.

As a result of the configuration of the hand-held power tool, a rotation speed for an impact drive can be optimized to a particularly effective number of impacts, and particularly rapid drilling progress in an impact drilling mode can thus be achieved with small external dimensions of the hand-held power tool.

It is further provided that the gearbox assemblage generate, in at least one operating state, at least two output rotary motions that have a non-integer ratio to one another. In at least one operating state, the gearbox assemblage preferably transfers one of the output rotary motions to the tool spindle and one of the output rotary motions to the hammer impact mechanism. A “non-integer ratio” is to be understood in particular as a ratio that lies outside a set of natural numbers. The ratio is preferably outside the set of natural numbers between 2 and 6. An “output rotary motion” is to be understood in particular as a rotary motion that directs a power output out of the gearbox assemblage. As a result of the non-integer ratio between the two output rotary motions, an advantageous impact pattern can be achieved which enables a particularly effective impact drilling mode.

In example embodiments, it is provided that the gearbox assemblage have at least one ring gear that is supported axially movably. “Supported axially movably” is to be understood as, in particular, movably in a direction parallel to a rotation axis of the ring gear. Advantageously, the ring gear is movable with respect to a hand-held power tool housing, with respect to at least one planet wheel of an identical gear stage, and/or with respect to at least one planet wheel of a further gear stage. Particularly advantageously, the ring gear is movable so that it is coupled simultaneously and/or successively with at least one respective planet wheel of two different gear stages. As a result of the axially movably supported ring gear, an overload clutch and/or an impact shutoff system can be implemented with a simple design, economically, and in a manner that saves installation space.

It is furthermore provided that the hand-held power tool have a spring element that, in at least one operating state, exerts a force on the axially movable ring gear, with the result that the ring gear is moved, advantageously automatically, in at least one direction and a configuration of simple design is thus possible.

It is further provided that the gearbox assemblage have at least one gear stage which is provided in order to increase a rotation speed for an impact drive, with the result that an advantageously high number of impacts, and thus an effective impact drilling procedure, can be achieved.

In example embodiments, it is provided that the hammer impact mechanism have a resilient lever element, supported pivotably around a pivot axis, which is provided in order to drive a striker of the hammer impact mechanism in at least one operating state. A “lever element” is to be understood in particular as a movable element on which at least two torques act at a distance, advantageously at a different distance, from the pivot axis. The lever element is preferably pivotable around a pivot axis that is oriented perpendicular to the rotation axis of the tool spindle. Particularly advantageously, the lever element is configured rotationally asymmetrically and/or movably less than 360° around a rotation axis. The term “resilient” is to be understood in particular to mean that at least one point of the lever element is deflected at least 1 mm relative to another point of the lever element during an operating state. Advantageously, the lever element is made at least partly of spring steel. The term “drive” is to be understood in particular in accelerating fashion. As a result of the lever element, an effective and economical hammer impact mechanism can be implemented with a simple design.

In example embodiments, it is provided that in at least one operating state, the striker be freely movable in a principal working direction. The striker is preferably movable by the lever element. “Freely movable” is to be understood in this connection to mean in particular that the striker is decoupled from components, except for a sliding and/or rolling friction in a guide, over at least one travel segment in the principal working direction. A “principal working direction” is to be understood in particular as an impact pulse direction of the hammer impact mechanism. As a result of the striker that is freely movable in at least one operating state, particularly high impact energy along with convenient and, in particular, low-vibration operation can be achieved.

It is further provided that the tool spindle have a rotary entrainment contour which is provided for creating an axially displaceable and nonrotatable connection along a rotation axis. The rotary entrainment contour transfers advantageously principally, particularly advantageously exclusively, rotational forces. The rotary entrainment contour is arranged as a rotary entrainment contour, such as in particular a spline shaft profile and/or advantageously such as a tooth set. Particularly advantageously, the tool spindle is arranged in two parts and the rotary entrainment contour connects the two parts of the tool spindle to one another. As a result of the rotary entrainment contour, advantageously, a ratio between the striker mass and spindle mass can be optimally selected and the tool spindle can be axially decoupled from the gearbox assemblage so that wear, in particular on a planet carrier of the gearbox assemblage, can be minimized.

It is further provided that the gearbox assemblage have at least one sun gear that, in at least one operating state, is connected nonrotatably, in particular directly (i.e. without further interposed components) nonrotatably to at least a part of the hammer impact mechanism, thereby making possible a particularly simple design that saves installation space. Advantageously, the sun gear is connected nonrotatably to a drive rotation element of the hammer impact mechanism.

Also provided are an electric motor and a battery connector unit which is provided for supplying the electric motor with energy. For this purpose, the battery connector unit is preferably connected, in a ready-to-operate operating state, to a battery unit. A “battery connector unit” is to be understood in particular as a unit which is provided in order to create a contact with the battery unit. Advantageously, the battery connector unit creates an electrical and a mechanical contact. A “battery unit” is to be understood in particular as an apparatus having at least one storage battery, which apparatus is provided in order to supply the hand-held power tool with energy independently of a power grid. A particularly convenient hand-held power tool that is usable independently of a power network can thereby be implemented. Alternatively, the hand-held power tool is also operable with a different motor such as, in particular, an electric motor having a power connector, or a compressed-air motor.

It is furthermore provided that the gearbox assemblage have a gear stage that is arranged as a planet wheel gear stage. The planet wheel gear stage has at least one sun gear, a ring gear, at least one planet wheel, and/or a planet carrier. As a result of the planet wheel gear stage, an advantageous reduction ratio can be achieved in particularly space-saving fashion.

It is moreover provided that the hammer impact mechanism have a releasable, in particular mechanically releasable clutch apparatus which is provided in order to transfer a rotary motion. Preferably the clutch apparatus nonrotatably connects an impact mechanism shaft of the hammer impact mechanism and at least a part of the gearbox assemblage in at least one operating state. A “releasable clutch apparatus” is to be understood in particular as a clutch apparatus that in at least one operating state transfers a rotary motion, and in at least one operating state interrupts a transfer of the rotary motion. “Transferring a rotary motion” is to be understood as conveying in particular a rotation speed and/or a torque. As a result of the releasable clutch apparatus, the hammer impact mechanism can advantageously be disengaged, thus resulting in a hand-held power tool that is advantageously usable as a screwdriver.

It is further provided that the clutch apparatus be provided in order to be closed by a force transferred via the tool spindle. The clutch apparatus is preferably provided in order to be closed by a force acting in an axial direction of the tool spindle. As a result of the clutch apparatus closable via the tool spindle, the hammer impact mechanism can, advantageously, automatically be engaged in the context of a drilling procedure and disengaged at idle, making possible low wear and convenient operation.

In example embodiments, it is provided that the hand-held power tool have a torque setting unit having a clutch apparatus, which is provided for limiting, in at least one operating state, a maximum torque transferred via the tool spindle. The clutch apparatus is advantageously releasable. The “maximum torque” is preferably a torque that the tool spindle can transfer to an inserted tool during operation, in particular before a clutch apparatus automatically opens. The clutch apparatus is preferably arranged as an apparatus having spring-mounted or spring-loaded latching elements such as, in particular, balls. Other apparatuses are, however, also possible in principle. The latching elements can be loaded with a spring force in an axial and/or preferably in a radial direction. Undesirably high torques can be prevented by a limitation of the maximum torque.

It is further provided that the hand-held power tool have an operating element by which the clutch apparatus can be actuated. Advantageously, at least the operator can actuate the clutch apparatus by the operating element and/or by the tool spindle. Alternatively and/or additionally, a sensor unit and an actuation unit can actuate the clutch apparatus at least partly automatically on the basis of material properties of a workpiece. The clutch apparatus of the torque setting unit and the clutch apparatus of the hammer impact mechanism preferably have one operating element each and/or one common operating element. “Actuation” is to be understood in particular as opening and/or closing of the clutch apparatus, with the result that the impact mode can be conveniently engaged and disengaged by the operator and, in particular, the clutch apparatus of the torque setting unit can be uninterruptedly closed in a drilling mode.

It is further provided that the hammer impact mechanism have a drive rotation element having a rotation axis that is disposed coaxially with at least a part of the tool spindle. A “drive rotation element” is to be understood in particular as an element that executes a rotary motion in at least one operating state, and that moves at least one further element of the hammer impact mechanism. Advantageously, the drive rotation element is arranged as a shaft, particularly advantageously as a hollow shaft. The term “coaxially” is to be understood in particular to mean that in at least one operating state, at least a part of the tool spindle and the drive rotation element are driven rotationally around a common rotation axis. Preferably, at least a part of the tool spindle and the drive rotation element are rotatable relative to one another around the same rotation axis. Particularly advantageously, the hand-held power tool is arranged without countershafts. “Without countershafts” is to be understood in particular to mean that all the shafts of the hand-held power tool that, at least in a drilling mode, transfer a rotary motion, have a common rotation axis that advantageously coincides with the rotation axis of the tool spindle. “At least a part of the tool spindle” is to be understood in particular as a region of the tool spindle that is connected directly to the tool mounting apparatus. Alternatively and/or additionally, “at least a part of the tool spindle” is to be understood as a region of the tool spindle that is connected directly to the gearbox assemblage. As a result of the fact that the drive rotation element is disposed coaxially with at least a part of the tool spindle, a particularly compact and, in particular, short configuration can be achieved. The hand-held power tool achieves in this context a particularly high level of individual impact energy, which advantageously results in particularly good drilling progress.

In example embodiments, it is provided that the drive rotation element be arranged as an impact mechanism shaft that encases at least a region of the tool spindle. An “impact mechanism shaft” is to be understood in particular as a shaft that transfers a rotary motion to at least one further element of the hammer impact mechanism in order to generate an impact. Particularly advantageously, the tool spindle and the impact mechanism shaft rotate, in at least one operating state, at a different angular speed. The term “encase” is to be understood in particular to mean that the impact mechanism shaft surrounds the tool spindle to a very large extent, advantageously over 360°, in at least one plane. Advantageously, this plane is oriented perpendicular to the rotation axis of the drive rotation element. As a result of a corresponding configuration, a particularly space-saving design can be achieved, and the impact mechanism shaft encasing the tool spindle can be implemented with a low tool spindle mass and a small tool spindle diameter.

It is further provided that the hammer impact mechanism have an eccentric element, with the result that a capable and mechanically low-wear hand-held power tool can be made available with a simple design.

It is moreover provided that the eccentric element have a rotation axis that coincides with a rotation axis of the tool spindle. The term “coincide” is to be understood in particular to mean that the eccentric element is supported rotationally drivably around a rotation axis identical to that of the tool spindle. Preferably, the eccentric element and at least a part of the tool spindle are connected nonrotatably to one another. As a result, it is advantageously possible to dispense with a countershaft, and a particularly handy and lightweight hand-held power tool can be achieved. In particular, a capable hand-held power tool having a weight (including a battery unit) of less than 5 kg, advantageously less than 2 kg, particularly advantageously less than 1.5 kg can be achieved.

In example embodiments, it is provided that the hammer impact mechanism have a striker that at least partly surrounds the tool spindle in at least one plane. In this context, the tool spindle advantageously penetrates at least partly through the striker in the direction of the rotation axis of the tool spindle. Particularly advantageously, the tool spindle penetrates entirely through the striker. The striker preferably surrounds the tool spindle over 360° in at least one plane. The phrase “surrounds over 360° in at least one plane” is to be understood in particular to mean that the striker radially encases at least one point of the tool spindle in at least one plane. As a result of the fact that the striker at least partly surrounds the tool spindle, advantageously a tool spindle having a low mass can be achieved, and a particularly lightweight and compact hand-held power tool with a high level of capability can thus be made available.

In example embodiments, it is provided that in at least one operating state, the striker impact the tool spindle. Advantageously, the striker thereby transfers an impact pulse onto at least a part of the tool spindle, the tool spindle advantageously transferring the impact pulse onto a tool mounting apparatus of the hand-held power tool. The tool mounting apparatus preferably transfers the impact pulse onto an inserted tool. Alternatively and/or additionally, the striker impacts an impact transfer apparatus such as a setting head, or directly impacts an inserted tool of the hand-held power tool. The impact transfer apparatus transfers an impact motion directly onto an inserted tool. For this, the impact transfer apparatus is, for example, disposed at least partly coaxially inside the tool spindle. As a result of the fact that the striker impacts the tool spindle directly, the tool spindle can advantageously transfer an impact motion and a rotary motion in combined fashion onto a tool mounting apparatus, with the result that, advantageously, an economical, universally usable tool mounting apparatus of simple design can be used, and installation space can in turn be reduced.

Further advantages are set forth in the description below of the drawings. Two exemplifying embodiments are depicted in the drawings. The drawings and the specification contain numerous features in combination. One skilled in the art will appropriately consider the features individually as well, and group them into further combinations.

### BRIEF DESCRIPTION OF THE DRAWINGS

FIG. 1 shows a hand-held power tool according to an example embodiment of the present invention having a schematically depicted drivetrain,

FIG. 2 is a functional sketch of the drivetrain of FIG. 1 having an electric motor, a gearbox assemblage, and a hammer impact mechanism,

FIG. 3 is a schematic partial section through the hammer impact mechanism of the hand-held power tool of FIG. 1,

FIG. 4 is a section through the hammer impact mechanism of FIG. 3,

FIG. 5 is a perspective depiction of a lever element of the hammer impact mechanism of FIG. 3, and

FIG. 6 is a functional sketch of an alternative exemplifying embodiment of the drivetrain of FIG. 1.

### DETAILED DESCRIPTION

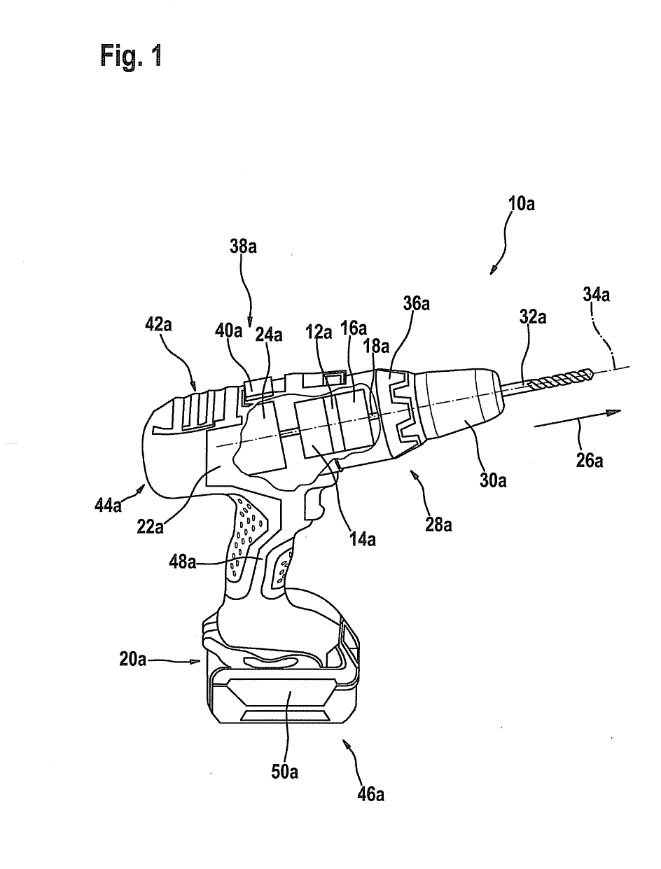

FIG. 1 is a partly schematic depiction of a hand-held power tool 10a that is arranged as a cordless impact drill driver. Hand-held power tool 10a has a torque setting unit 12a, a gearbox assemblage 14a, a hammer impact mechanism 16a, a tool spindle 18a, a battery connector unit 20a, a pistol-shaped hand-held power tool housing 22a, and an electric motor 24a disposed in hand-held power tool housing 22a. In a front region 28a of hand-held power tool 10a, viewed oppositely to a principal working direction 26a of hand-held power tool 10a, hand-held power tool 10a has a tool mounting apparatus 30a that is arranged as a tool chuck. Mounted in tool mounting apparatus 30a is an inserted tool 32a that, during operation of hand-held power tool 10a, rotates around a rotation axis 34a of tool spindle 18a that extends parallel to principal working direction 26a. Rotation axis 34a is arranged as a principal rotation axis, i.e. multiple elements of hand-held power tool 10a are rotatable about said rotation axis 34a.

An operating element 36a of torque setting unit 12a is disposed annularly around rotation axis 34a of tool spindle 18a, between hand-held power tool housing 22a and tool mounting apparatus 30a. Disposed on an upper side 38a, i.e. a side facing away from battery connector unit 20a, of hand-held power tool 10a is an operating element 40a that enables an operator (not further depicted) to change over between a drilling or screwing mode and a hammer drilling mode.

Electric motor 24a is disposed in a rear region 42a, i.e. a region facing away from tool mounting apparatus 30a, of hand-held power tool housing 22a. A stator (not further depicted) of electric motor 24a is connected nonrotatably to hand-held power tool housing 22a. Gearbox assemblage 14a is disposed in a tubular upper region 44a, disposed axially with respect to rotation axis 34a, of the pistol-shaped hand-held power tool housing 22a. A lower region 46a of hand-held power tool housing 22a, which adjoins upper region 44a approximately at right angles, forms a handle 48a. Battery connector unit 20a is disposed at a lower end of lower region 46a. In a ready-to-operate state (as shown), a battery unit 50a is connected to battery connector unit 20a. During operation, battery unit 50a supplies electric motor 24a with energy.

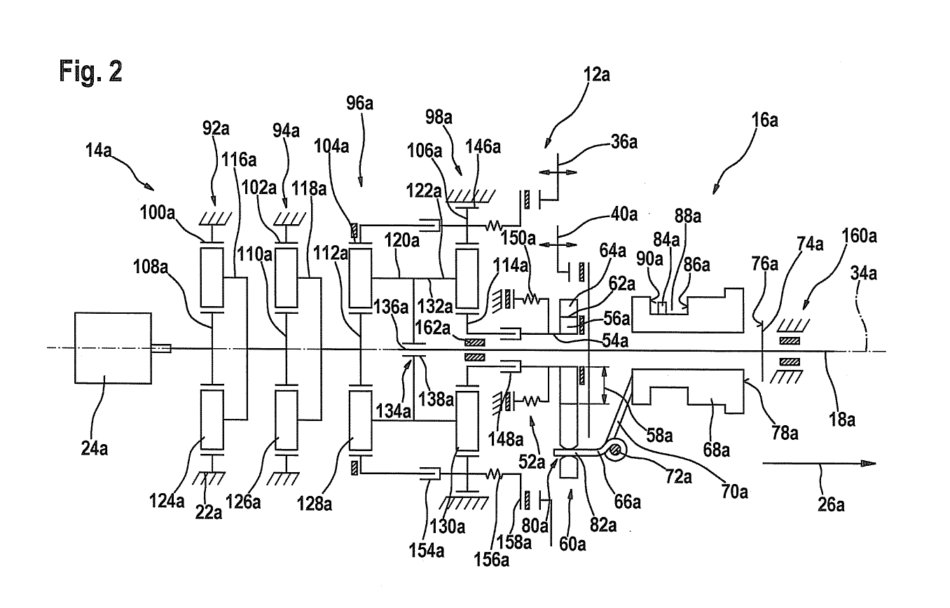

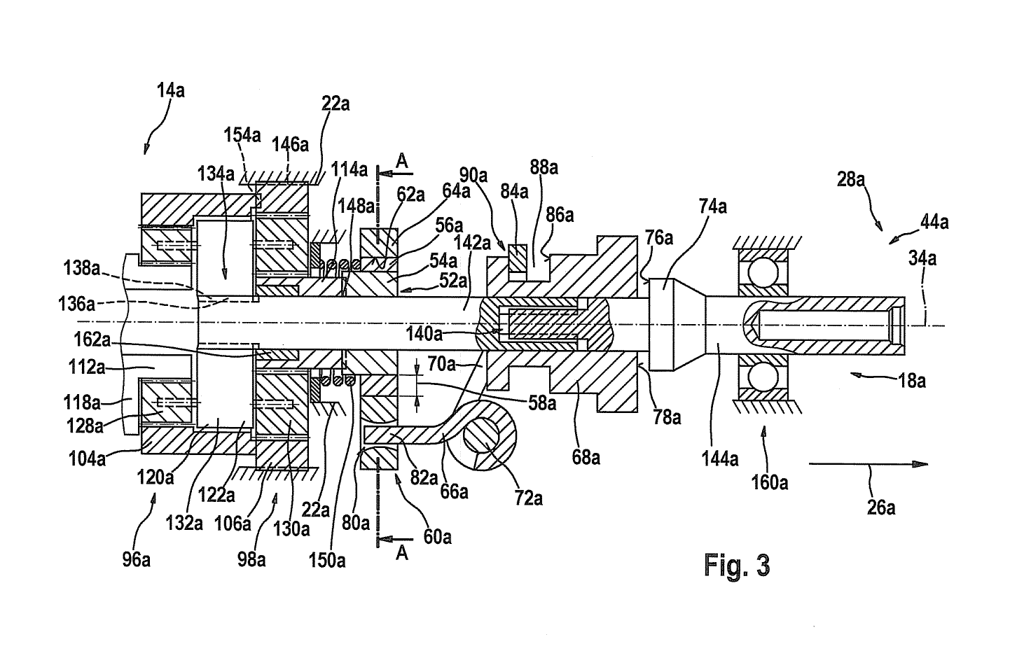

As FIGS. 2 and 3 show, hammer impact mechanism 16a has a drive rotation element 52a having a rotation axis 34a that is disposed coaxially with respect to tool spindle 18a. Drive rotation, element 52a is arranged as an impact mechanism shaft 54a. Impact mechanism shaft 54a encases a region of tool spindle 18a that faces toward gearbox assemblage 14a. Rotation axis 34a of impact mechanism shaft 54a is oriented parallel to principal working direction 26a of hand-held power tool 10a. Tool spindle 18a connects tool mounting apparatus 30a to gearbox assemblage 14a along rotation axis 34a nonrotatably, and is arranged for the most part as a solid shaft.

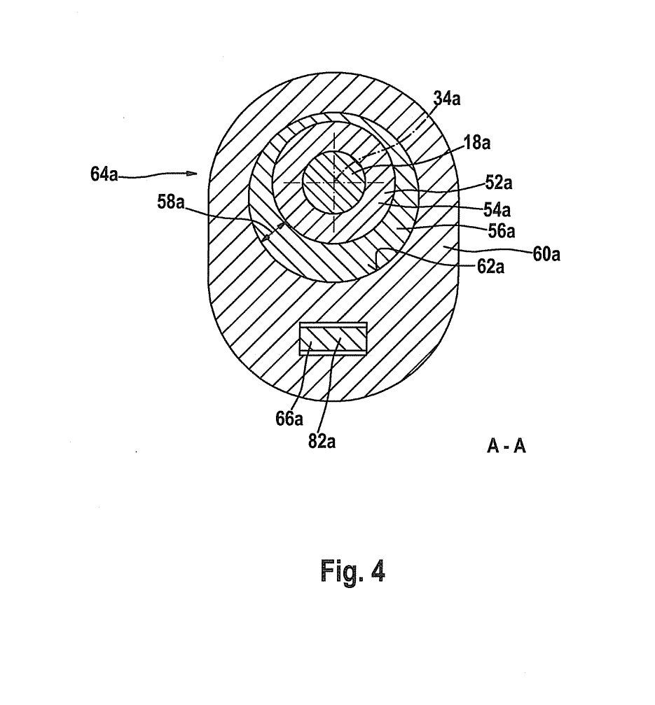

Hammer impact mechanism 16a is embodied as an eccentric impact mechanism that has an eccentric element 56a. As shown by the section (A-A) depicted in FIG. 4, eccentric element 56a has a rotation axis that coincides with rotation axis 34a of tool spindle 18a. Eccentric element 56a is constituted by a sleeve whose wall thickness 58a continuously increases and then decreases over a 360-degree circuit around rotation axis 34a. Eccentric element 56a is connected nonrotatably to impact mechanism shaft 54a, and is penetrated by the latter in an axial direction. Hammer impact mechanism 16a has an eccentric outer element 60a that is moved by eccentric element 56a during a hammer drilling mode. Eccentric outer element 60a is arranged as an approximately elliptical disk. It has a round orifice 62a that is disposed in a region 64a, facing away from handle 48a, of eccentric outer element 60a. Eccentric element 56a is supported in orifice 62a, movably relative to eccentric outer element 60a, by way of a bearing (not further depicted). Eccentric outer element 60a further has an aperture 80a that is disposed in a region, facing toward handle 48a, of eccentric outer element 60a. Aperture 80a is penetrated by a resilient lever element 66a. Lever element 66a prevents a rotation of eccentric outer element 60a in a circumferential direction relative to hand-held power tool housing 22a.

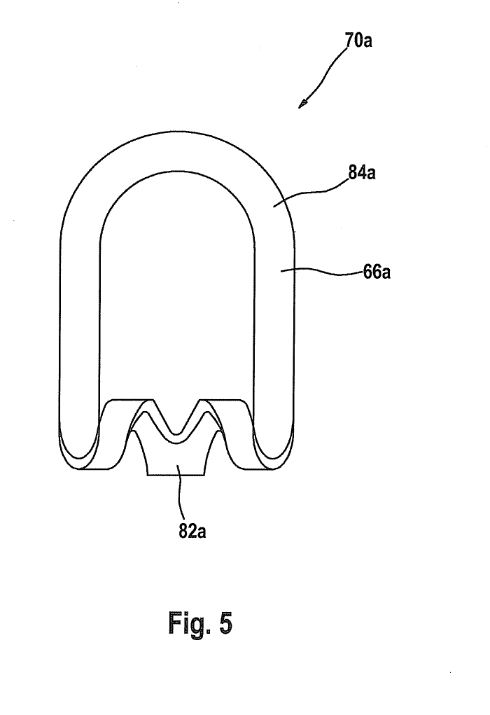

Hammer impact mechanism 16a has a striker 68a. Lever element 66a drives striker 68a during a hammer drilling mode. Lever element 66a is arranged as a bracket, L-shaped in a side view, made of spring steel. As FIG. 5 shows, lever element 66a has a horseshoe-shaped region 70a that is penetrated by tool spindle 18a. Hammer impact mechanism 16a has a housing-mounted pivot shaft 72a around which lever element 66a is tiltable. Housing-mounted pivot shaft 72a is oriented perpendicular to rotation axis 34a of tool spindle 18a.

FIGS. 2 and 3 further show that striker 68a of hammer impact mechanism 16a is freely movable in principal working direction 26a during a free-flight phase. The free-flight phase is a time period that begins with the end of an acceleration of striker 68a by lever element 66a, and ends immediately before an impact. Upon impact, striker 68a transfers an impact pulse to tool spindle 18a. For this, striker 68a impacts a transfer element 74a of tool spindle 18a. Transfer element 74a is arranged as a thickening of tool spindle 18a that has a surface 76a, on the side facing toward striker 68a. Surface 76a is oriented parallel to an impact surface 78a of striker 68a. Striker 68a surrounds tool spindle 18a over 360° in planes that are oriented perpendicular to rotation axis 34a of tool spindle 18a. Striker 68a is guided on tool spindle 18a and is supported rotatably, with respect to hand-held power tool housing 22a, around rotation axis 34a of tool spindle 18a. Alternatively, the striker can also be guided at its outer contour and/or can be rotationally secured with respect to the hand-held power tool housing.

Upon a rotation of eccentric element 56a, eccentric outer element 60a moves perpendicular to rotation axis 34a of tool spindle 18a. As a result of a motion of eccentric outer element 60a, an end 82a, disposed tiltably in aperture 80a of eccentric outer element 60a, of lever element 66a is moved, and lever element 66a is thereby tilted. Lever element 66a thereby accelerates striker 68a out of an initial position, facing toward gearbox assemblage 14a, in the direction of principal working direction 26a, by the fact that a driving end 84a of lever element 66a presses against a first bracing surface 86a of striker 68a. After acceleration, striker 68a moves in principal working direction 26a into the free-flight phase, in which driving end 84a of lever element 66a is disposed in a free region 88a of striker 68a and is thus decoupled from striker 68a in principal working direction 26a. At the end of this free-flight phase, striker 68a encounters transfer element 74a of tool spindle 18a and transfers its momentum to tool spindle 18a. Lever element 66a then moves striker 68a back into the initial position by the fact that driving end 84a of lever element 66a exerts a force on a second bracing surface 90a of striker 68a, said surface being disposed, with reference to first bracing surface 86a, on a different side of free region 88a. As a result of the resilient configuration of lever element 66a, smooth profiles are achieved for the forces that act between lever element 66a and striker 68a.

Gearbox assemblage 14a has four gear stages, which are embodied as planet wheel gear stages 92a, 94a, 96a, 98a. The four planet wheel gear stages 92a, 94a, 96a, 98a are disposed behind one another along rotation axis 34a of tool spindle 18a. The four planet wheel stages 92a, 94a, 96a, 98a each have a ring gear 100a, 102a, 104a, 106a, a sun gear 108a, 110a, 112a, 114a, a planet carrier 116a, 118a, 120a, 122a, and four planet wheels 124a, 126a, 128a, 130a, only two of which are depicted in each case. Planet wheels 124a of first planet wheel gear stage 92a mesh with sun gear 108a of first planet wheel gear stage 92a and with ring gear 100a of first planet wheel gear stage 92a, and are supported rotatably on planet carrier 116a of first planet wheel gear stage 92a. Planet carrier 116a of first planet wheel gear stage 92a guides planet wheels 124a of first planet wheel gear stage 92a on a circular path around rotation axis 34a of tool spindle 18a.

Second planet wheel gear stage 94a, third planet wheel gear stage 96a, and fourth planet wheel gear stage 98a are constructed correspondingly thereto.

Sun gear 108a of first planet wheel gear stage 92a is connected nonrotatably to electric motor 24a and is disposed next to electric motor 24a in principal working direction 26a, between tool mounting apparatus 30a and electric motor 24a. Ring gear 100a of first planet wheel gear stage 92a is connected nonrotatably to hand-held power tool housing 22a. Planet carrier 116a of first planet wheel gear stage 92a is connected nonrotatably to sun gear 110a of second planet wheel gear stage 94a, ring gear 102a of which is likewise connected to hand-held power tool housing 22a. Planet carrier 118a of second planet wheel gear stage 94a is connected nonrotatably to sun gear 112a of third planet wheel gear stage 96a. Ring gear 104a of third planet wheel gear stage 96a is likewise connected nonrotatably to hand-held power tool housing 22a during a drilling, screwdriving, or hammer drilling procedure. The first, the second, and the third planet wheel gear stage 92a, 94a, 96a thus each bring about a gear reduction in the direction of tool mounting apparatus 30a. A gear reduction thus likewise occurs between sun gear 108a of first planet wheel gear stage 92a and planet carrier 120a of third planet wheel gear stage 96a. A ratio of this gear reduction between a rotation speed of electric motor 24a and a rotation speed of tool spindle 18a is equal to approximately 60:1.

In addition, one skilled in the art is familiar with possibilities for switching to an alternative conversion ratio between a rotation speed of electric motor 24a and a rotation speed of tool spindle 18a. For example, ring gear 102a of second planet wheel gear stage 94a can be nonrotatably connectable, alternatively to hand-held power tool housing 22a, to planet carrier 116a of first planet wheel gear stage 92a by way of a clutch apparatus (not further depicted). The alternative conversion ratio between the rotation speed of a motor speed and the rotation speed of tool spindle 18a is equal to approximately 15:1.

Gearbox assemblage 14a has a gear stage element 132a that splits a power flow. Gear stage element 132a is embodied as a common planet carrier 120a, 122a of the third and the fourth planet wheel gear stage 96a, 98a. Tool spindle 18a has a rotary entrainment contour 134a that creates, along rotation axis 34a, an axially displaceable and nonrotatable connection to gearbox assemblage 14a, more precisely to gear stage element 132a. A pickoff of rotation speed of tool spindle 18a accordingly occurs at planet wheel 120a of third planet wheel gear stage 96a.

In this example, rotary entrainment contour 134a is arranged as an internal tooth set 136a of gear stage element 132a and an external tooth set 138a of tool spindle 18a. Alternatively, pickoff could occur at the ring gear of third planet wheel gear stage 96a.

Alternatively or in addition to rotary entrainment contour 134a shown in FIG. 2 and previously described, a rotary entrainment contour 140a can, as shown in FIG. 3, divide tool spindle 18a axially into two parts 142a, 144a. The one part 142a of tool spindle 18a is connected directly to gearbox assemblage 14a. The other part 144a of tool spindle 18a is connected directly to tool mounting apparatus 30a. The previously described rotary entrainment contour 134a can be omitted. Part 142a of tool spindle 18a that is connected directly to gearbox assemblage 14a can then be connected fixedly in an axial direction to gear stage element 132a. As a result, a mass of the axially movable part 144a of tool spindle 18a can be reduced.

Sun gear 114a of fourth planet wheel gear stage 98a is connected, during a hammer drilling mode, nonrotatably to drive rotation element 52a. Sun gear 114a of fourth planet wheel gear stage 98a is thus, in the context of a hammer drilling procedure, connected nonrotatably to eccentric element 56a of hammer impact mechanism 16a. Alternatively, ring gear 106a of fourth planet wheel gear stage 98a could also be connected nonrotatably to drive rotation element 52a.

Ring gear 106a of fourth planet wheel gear stage 98a is supported axially movably. Gearbox assemblage 14a has a coupling element 146a that connects ring gear 106a of fourth planet wheel gear stage 98a nonrotatably and axially displaceably to hand-held power tool housing 22a. As a result of this disposition, gearbox assemblage 14a—more precisely fourth planet wheel gear stage 98a—generates from the two power flows of the common planet carrier 120a, 122a of the third and the fourth planet wheel gear stage 96a, 98a, during a hammer drilling mode, output rotary motions that have a non-integer ratio to one another. In addition, fourth planet wheel gear stage 98a increases a rotation speed for an impact drive, i.e. a rotation speed of impact mechanism shaft 54a or of drive rotation element 52a is higher than a rotation speed of tool spindle 18a. Gearbox assemblage 14a—more precisely gear stage element 132a—thus makes available different rotation speeds for an impact drive and a rotary drive.

Hand-held power tool 10a has a first releasable clutch apparatus 148a that transfers a rotary motion during a hammer drilling mode. First clutch apparatus 148a is arranged as a claw clutch, and remains closed in the context of an axial motion of tool spindle 18a caused by an impact. In a hammer drilling mode, first clutch apparatus 148a connects hammer impact mechanism 16a to sun gear 114a of fourth planet wheel gear stage 98a.

First clutch apparatus 148a furthermore has a spring element 150a that is arranged as a spiral spring. Spring element 150a opens first clutch apparatus 148a when tool spindle 18a is unloaded oppositely to principal working direction 26a. In this case hammer impact mechanism 16a is deactivated. First clutch apparatus 148a is closed during a hammer drill mode by a force transferred via tool spindle 18a in an axial direction and proceeding from inserted tool 32a. When tool spindle 18a is loaded with a force, as a result of a force generated by the operator onto a workpiece (not further depicted) via an inserted tool 32a mounted in tool mounting apparatus 30a, spring element 150a is compressed and first clutch apparatus 148a is closed. The force is applied in an axial direction in the context of a hammer drilling mode, via a shaped element 152a that is connected to tool spindle 18a, onto impact mechanism shaft 54a and thus onto first clutch apparatus 148a.

In addition, hand-held power tool 10a has operating element 40a with which the operator can actuate first clutch apparatus 148a by uninterruptedly opening first clutch apparatus 148a. Hammer impact mechanism 16a is thus deactivated in this operating state. This operating element 40a thus enables a manual changeover between a drilling or screwdriving mode and a hammer drilling mode, and drilling and screwdriving can be performed with hand-held power tool 10a without an impact pulse. Operating element 40a is embodied as a slide switch.

Torque setting unit 12a has a clutch apparatus 154a that limits a transferable torque. A maximum torque is settable by torque setting unit 12a. This further, second clutch apparatus 154a is disposed between ring gear 104a of third planet wheel gear stage 96a and ring gear 106a of fourth planet wheel gear stage 98a. Second clutch apparatus 154a opens automatically at a settable maximum torque that acts on tool spindle 18a. When second clutch apparatus 154a is open, ring gear 104a of third planet wheel gear stage 96a is axially secured and rotationally movable. Second clutch apparatus 154a is arranged as an overload clutch, known to one skilled in the art, the response torque of which is modifiable by an axial force on second clutch apparatus 154a. For example, second clutch apparatus 154a is arranged as a shaped-element clutch having oblique surfaces, or as a friction clutch. Alternatively, ring gear 106a of fourth planet wheel gear stage 98a serves as a shaped element, by the fact that it meshes simultaneously with planet wheels 128a, 130a of third planet wheel gear stage 96a and of fourth planet wheel gear stage 98a and, when the maximum torque is exceeded, becomes displaced in principal working direction 26a and releases planet wheels 128a of third planet wheel gear stage 96a. For this purpose, ring gear 106a of fourth planet wheel gear stage 98a is preferably arranged to be wider than planet wheels 128a, 130a of the third and/or the fourth planet wheel gear stage 96a, 98a.

Hand-held power tool 10a has a spring element 156a that, during a working procedure, exerts a force on the axially movable ring gear 106a of fourth planet wheel gear stage 98a and thus on second clutch apparatus 154a, and thus closes second clutch apparatus 154a. By operating element 36a of torque setting unit 12a, second clutch apparatus 154a can be shifted by the operator, i.e. a force on the axially movable ring gear 106a can be set. This is done by an axial motion of a contact point 158a of spring element 156a. When the maximum torque of tool spindle 18a is exceeded and clutch apparatus 154a is not uninterruptedly closed manually, second clutch apparatus 154a produces a counterforce and compresses spring element 156a, and clutch apparatus 154a opens. Operating element 36a of torque setting unit 12a is arranged as a ring rotatable by the operator.

Operating element 36a further has a shaped element (not further depicted) which is provided in order to manually close second clutch apparatus 154a uninterruptedly. This is done by a corresponding setting, by the operator, of operating element 36a. Opening of second clutch apparatus 154a in the context of a drilling mode can thereby be prevented at all torques that are transferred via tool spindle 18a and do not exceed a safety torque.

Gearbox assemblage 14a has two bearing elements 160a, 162a that radially support tool spindle 18a. First bearing element 160a is disposed on the side of tool spindle 18a facing toward tool mounting apparatus 30a. First bearing element 160a is connected axially fixedly to tool spindle 18a, and is supported axially displaceably in hand-held power tool housing 22a. Alternatively, the first bearing element can also be connected axially fixedly to the hand-held power tool housing, and supported axially displaceably on the tool spindle. Disposed on the side of tool spindle 18a facing away from tool mounting apparatus 30a is second bearing element 162a, which supports tool spindle 18a inside sun gear 114a of fourth planet wheel gear stage 98a. Alternatively, tool spindle 18a can be supported by the common planet carrier 120a, 122a of the third and the fourth planet wheel gear stage 96a, 98a.

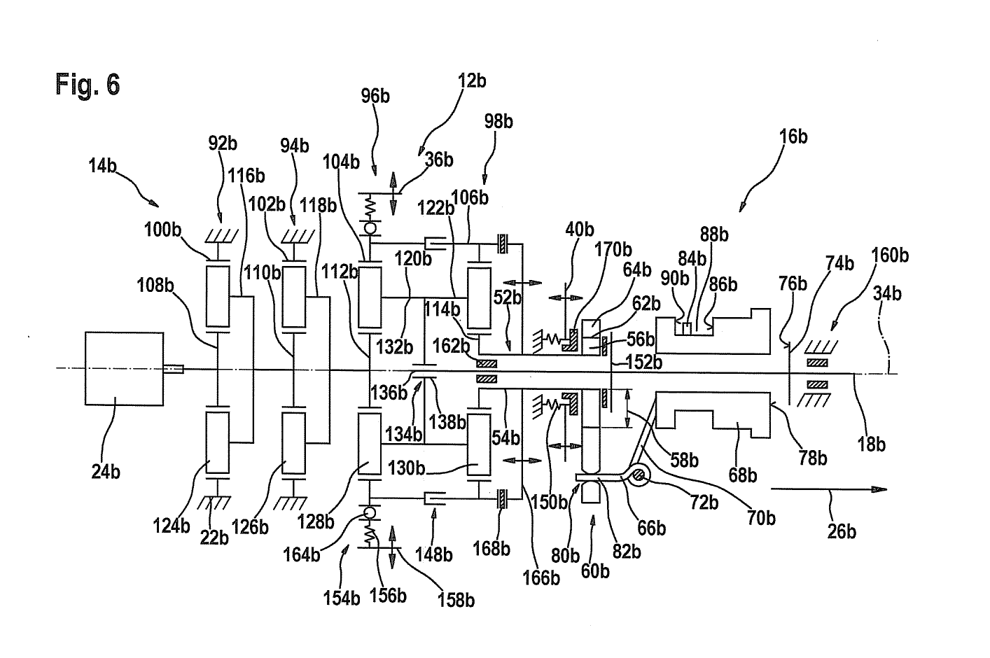

FIG. 6 shows a further exemplifying embodiment. To differentiate the exemplifying embodiments, the letter “a” in the reference characters of the exemplifying embodiment in FIGS. 1 to 5 is replaced by letters “b” in the reference characters of the exemplifying embodiment in FIG. 6. The description that follows is limited substantially to the differences with regard to the exemplifying embodiment in FIGS. 1 to 5; reference may be made, with regard to components, features and functions that remain the same, to the description of the exemplifying embodiment in FIGS. 1 to 5. In particular, different dispositions and combinations of the above-described clutch apparatus are possible.

FIG. 6, like FIG. 2, shows in particular a torque setting unit 12b, a gearbox assemblage 14b, a hammer impact mechanism 16b, and a tool spindle 18b.

Torque setting unit 12b has latching elements 164b that are arranged as balls. Latching elements 164b are supported in shaped elements (not further depicted) and are disposed between a ring gear 104b of a third planet wheel gear stage 96b and a hand-held power tool housing 22b. Latching elements 164b are spring-loaded radially to a rotation axis 34b of tool spindle 18b, by a spring element 156b of torque setting unit 12b, with a force that is settable by the operator. If a torque transferred via tool spindle 18b exceeds a set maximum torque, latching elements 164b push the shaped elements apart against a force of spring element 156b. Ring gear 104b of third planet wheel gear stage 96b thus rotates relative to hand-held power tool housing 22b, and tool spindle 18b transfers no torque at that time.

Ring gear 104b of third planet wheel gear stage 96b and a ring gear 106b of a fourth planet wheel gear stage 98b are nonrotatably connected to one another by a clutch apparatus 148b. When clutch apparatus 148b is opened, ring gear 106b of fourth planet wheel gear stage 98b is freely rotatable around rotation axis 34b, and hammer impact mechanism 16b is thus disengaged for a drilling and screwdriving mode.

Clutch apparatus 148b is closed by two shaped elements 152b, 168b. First shaped element 152b transfers a force in an axial direction from tool spindle 18b onto an impact mechanism shaft 54b. This shaped element 152b is axially mechanically connected fixedly to tool spindle 18b.

Second shaped element 166b is connected in an axial direction to impact mechanism shaft 54b. Said element transfers force in an axial direction via a bearing 168b to ring gear 106b of fourth planet wheel gear stage 98b. The force closes clutch apparatus 148b in the context of a drilling and screwdriving mode. Alternatively, a transfer of force via fourth planet wheel gear stage 98b is possible. Clutch apparatus 148b is opened by a spring element 150b that applies axial force, directed onto a tool mounting apparatus 30b, onto impact mechanism shaft 54b via a bearing 170b.

1-15. (canceled)

16. A hand-held power tool, comprising:
a gearbox assemblage;
a hammer impact mechanism; and
a tool spindle;
wherein the gearbox assemblage includes at least one gear stage element adapted to split a power flow so as to make available different rotation speeds for an impact mode and a rotation mode.

17. The hand-held power tool according to claim 16, wherein the hand-held power tool is arranged as an impact drill driver.

18. The hand-held power tool according to claim 16, wherein the gearbox assemblage is adapted to generate, in at least one operating state, at least two output rotary motions that have a non-integer ratio to one another.

19. The hand-held power tool according to claim 16, wherein the gearbox assemblage includes at least one ring gear that is supported axially movably.

20. The hand-held power tool according to claim 19, further comprising a spring element adapted to, in at least one operating state, exert a force on the axially movable ring gear.

21. The hand-held power tool according to claim 16, wherein the gearbox assemblage includes at least one gear stage adapted to increase a rotation speed for an impact drive.

22. The hand-held power tool according to claim 16, wherein the tool spindle includes a rotary entrainment contour adapted to create an axially displaceable and nonrotatable connection along a rotation axis.

23. The hand-held power tool according to claim 16, wherein the gearbox assemblage includes at least one sun gear that, in at least one operating state, is connectable nonrotatably to at least a part of the hammer impact mechanism.

24. The hand-held power tool according to claim 16, wherein the gearbox assemblage includes a gear stage that is arranged as a planet wheel gear stage.

25. The hand-held power tool according to claim 16, further comprising a torque setting unit including a clutch apparatus adapted to limit, in at least one operating state, a maximum torque transferrable via the tool spindle.

26. The hand-held power tool according to claim 25, further comprising an operating element adapted to actuate the clutch apparatus.

27. The hand-held power tool according to claim 16, wherein the hammer impact mechanism includes a drive rotation element having a rotation axis arranged coaxially with at least a part of the tool spindle.

28. The hand-held power tool according to claim 27, wherein the drive rotation element is arranged as an impact mechanism shaft that encases at least a region of the tool spindle.

29. The hand-held power tool according to claim 16, wherein the hammer impact mechanism includes an eccentric element.

30. The hand-held power tool according to claim 29, wherein the eccentric element includes a rotation axis that coincides with a rotation axis of the tool spindle.

31. The hand-held power tool according to claim 16, wherein the hammer impact mechanism includes a striker that at least partly surrounds the tool spindle in at least one plane.
